(19) United States
(12) Patent Application Publication
(10) Pub. No.: US 2003/0108646 A1
(43) Pub. Date: Jun. 12, 2003

(54) Fluid absorbent pad primarily for food products

(76) Inventors: Lawrence O'Connor, Nokomis, FL (US); Robert Amborsky, Winnipeg (CA); Jules B. Pequignot, Fort Wayne, IN (US); Thomas R. Lucas, Fort Wayne, IN (US); Jan M. Dwiggins, Findlay, OH (US)

Correspondence Address: ADE & COMPANY, 1700-360 MAIN STREET, WINNIPEG, MB, R3C3Z3, CA

(21) Appl. No.: 10/012,364

(22) Filed: Dec. 12, 2001

(51) Int. Cl. C12C 3/04

(52) U.S. Cl. 426/392

(57) ABSTRACT

A pad for collecting liquid exudate from food products is formed by a top and bottom sheet of plastics film with the bottom sheet shaped to define pockets which contain super absorbent particles and are closed by the top sheet. The pockets are perforated at least at the bottom and possibly at the top sheet. The pockets may be stiff enough to hold the parts of the bottom sheet spaced from at the support surface of a tray so as to define channels under the food product through which the exudate can run to access a number of the pockets to avoid unbalanced overloading of the pockets. The pockets are formed in rows and columns where there is overlap at least on one direction to form the channels in diagonal directions of the pad.

This invention relates to a fluid absorbent pad designed primarily but not exclusively for use with food products such as meat to absorb juices released from the product during storage.

### BACKGROUND OF THE INVENTION

The product of the present invention is intended to be used for meat (poultry, red meat, and seafood) packaging applications. Typically an absorbent pad of some type is placed under the meat during packaging. This is intended to absorb the fluid (exudate) exiting the meat. Common products now include airlaids with film covers, or perforated film pouches with absorbent material of some type inside. Super absorbent materials are often used and different types of such materials are available to and well known to persons skilled in this art. Such materials are often known as superabsorbent polymers (SAP) and examples are polysacharides or polyacrylates; but the present invention is not intended to be limited to polymers and may include othe rmaterials which act as superabsorbents. Such materials can be supplied in particulate, liquid or fiber form. Thus the absorbent material can include tissue, tissue with super absorbent materials (SAP), SAP laminates, or airlaids. Some disadvantages of these methods are:

Delamination of the absorbent products and subsequent attachment of fibers to the meat.

Discoloration of the packages.

A “ballooning” of the package and possible rupture causing the activated SAP to get on the meat.

Gel blocking of the absorbent packages, by the SAP forming a gel which interferes with liquid flow, resulting in exudate not being fully absorbed, creating more bacteria growth and increasing the potential of leakage from the package.

Too much absorbency from the SAP in direct contact with the meat resulting in dessication of the meat.

All these issues are becoming more critical in recent years as the meat industry is going to “case-ready” packaging, meaning that the meat is placed into packages, shipped to the grocer, and sold directly to the consumer.

A typical pad for this purpose was disclosed by Miller in his U.S. Pat. No. 4,275,811 issued 1981 which comprises fibrous pad contained between a top and bottom sheet of plastics material. Typically the top sheet is impervious and the bottom sheet is perforated so that the exudate passes around the edges of the pad to the bottom for absorption by the fibrous material through the bottom sheet.

Addditonal absorption can be provided by introducing SAP between the fibers of the fibrous layer. However this provides the problems and disadvanteges set forth above.

Another pad of this general type is shown in U.S. Pat. No. 5,789,076 (Isohata) assigned to Showa Denko which discloses pores of a particular character in the top sheet.

A tray for food products is disclosed in U.S. Pat. No. 3,328,346 (Peppler) assigned to Diamond International which discloses a top sheet which is imperforate so that exudate runs around edges of the sheet into a collection area underneath the top sheet defined by raised projections from the bottom of the tray.

U.S. Pat. No. 6,270,873 (Darnet) assigned to Sealed Air Corporation and/or Therma Rite and discloses two types of pad one for absorption of exudate into SAP and another for cooling the food product by freezing of the gelled SAP. The absorption pad provides a construction with a low number of pockets such as 12 pockets defined between top and bottom sheets with each pocket containing SAP. The top sheet is preferably a laminate of at least one and preferably two microperforated sheets with a paper sheet which acts to inhibit the escape of the SAP though the top sheet to the product while allowing absorption of the exudate through the top sheet. The large pads or pockets provided in this arrangement will limit the absorption of the exudate from the bottom of the pocket by gel blocking and by the filling of one pocket blocking access of the exudate to other pockets. The microperforated top sheet material requires the use of special material thus increasing cost. This product is apparently not on the market. The Sealed Air Products advertised on their web site, and actually seen in meat packages, is a version with no perforations or micro-perforations on the top film.

U.S. Pat. No. 6,054,631 (Gent) assigned to Bristol Myers discloses a pad primarily for health care products where the SAP is contained between two sheets and is compressed to form compressed areas and voids therebetween.

U.S. Pat. No. 4,055,180 (Karami) assigned to Colgate Parmolive discloses a pad primarily for health care products where the SAP is contained in pockets defined above a conventional pad.

U.S. Pat. No. 4,892,535 (Bjornberg) discloses a pad primarily for health care products where fibrous absorbent formed into islands is contained in pockets between an impervious top sheet and a fibrous bottom sheet.

PaperPak Corporation provides literature which indicates that they have patented products.

Another key player is Sealed Air Corporation who provides a pad of this type.Linpac Plastics provides a tray that combines the absorbent properties withinthe tray. This is being used widely in Europe but not so much in North America yet.

Lysac makes SAP that has been approved by the FDA for direct food contact. They also claim that their SAP will not swell as much as other competitive SAP after absorbing the same amount of fluid.

Degussa makes SAP that has been approved by the FDA for indirect food contact.

### SUMMARY OF THE INVENTION

It is one object of the present invention, therefore, to provide an improved method of packaging a food product which releases an exudate.

According to a first aspect of the invention, therefore, there is provided method for packaging a food product having a liquid exudate from the product, the method comprising:

providing an absorbent layer for absorbing the exudate from the product and locating the product on the layer;

locating the layer on a liquid impermeable, non absorbent support surface;

wherein the layer comprises:

a top sheet of a liquid impermeable material;

a bottom sheet;

the top and bottom sheets being laminated together to form a plurality of pockets therebetween;

the pockets each containing a quantity of a super absorbent material (SAM);

the pockets being spaced each from the next to define channels between the pockets which channels are located underneath the bottom sheet so as to be located between the bottom sheet and the support surface;

the bottom sheet being liquid permeable at least at the pockets to allow penetration of the exudate into the pockets for absorption by the SAM;

the top and bottom sheets being perforated between the pockets such that exudate on the top sheet can pass through both the top and bottom sheets into the channels for absorption through the bottom sheet into the pockets.

Preferably the pockets are spaced and arranged such that the pockets define a plurality of channels underneath the product in a longitudinal direction of the pad and a plurality of channels underneath the product in a transverse direction of the pad. Such an array of pockets in rows and columns can contain the SAM in particulate form.

In another arrangement, the pockets can be elongate and receive the SAM in fiber form with the fibers lying longitudinally along the length of the elongate pockets.

Preferably the top sheet is substantially flat so as to define a top flat surface on which the food product sits.

Preferably the bottom sheet is arranged such that, at least when exudate is absorbed by the SAP, the pockets are shaped to project downwardly from the top sheet to support the top sheet at the channels away from the support surface to allow free flow of the exudate in the channels between the bottom sheet and the support surface.

Preferably the layer consists only of the top and bottom sheets with the SAP in the pockets and thus is of minimum material and cost. However more complex constructions can also be used.

Preferably the top and bottom sheets are each formed of a single layer only of a plastics material thus again providing minimum material.

Preferably the SAP in non-hydrated form only partly fills pocket leaving an upper air space underneath the top sheet.

Preferably the amount of the SAP in each pocket is arranged such that the pocket not filled when the SAP therein is fully hydrated.

Preferably the pockets are arranged such that the pockets project downwardly from the top sheet to support the top sheet at the channels away from the support surface to allow free flow of the exudate in the channels between the bottom sheet and the support surface. This can be achieved by the bulk of the SAP holding the sheet distorted into bulging pockets or it can be achieved by the shape and arrangement of the bottom sheet which is stiff enough to support the top sheet raised from the support surface.

Preferably the pockets contain only SAP with no fibrous absorbent material therein.

Preferably the pockets are arranged in rows and columns and wherein the pockets of each row overlap with the pockets of the next adjacent row to achieve a high number of pockets each of relatively small dimension to provide a high level of SAP and a large number of channels to communicate with the pockets.

Preferably the pockets are arranged in rows and columns and wherein the channels between the pockets extend diagonally of the rows and columns.

Preferably the pockets are arranged in rows and columns each containing more than four.

Preferably there are more than 16 pockets on the pad.

Preferably there is provided a band across the layer which is free from pockets allowing the layer to be cut across the band without cutting through a pocket.

The layer can form a separate element for application to and use in a tray so that the support surface comprises the bottom of the tray.

Alternatively the technology may be incorporated directly into a tray where the top sheet, the bottom sheet and the support surface all form integral components of a tray.

Preferably the bottom sheet is formed from impermeable plastics material which is perforated at the pockets.

Alternatively the bottom sheet is formed from a non woven fibrous material which is permeable to liquid and which is impermeable to the SAP.

According to a second aspect of the invention there is provided an absorbent layer for absorbing the exudate from a food product comprising;

a top sheet of a liquid impermeable material;

a bottom sheet arranged to be placed upon a support surface so as to be at least partly in contact therewith;

the top and bottom sheets being laminated together to define a plurality of pockets therebetween;

the pockets each containing a quantity of a super absorbent particulate material (SAP);

the pockets being spaced each from the next to define channels between the pockets which channels are located underneath the bottom sheet so as to be located between the bottom sheet and the support surface;

the bottom sheet being liquid permeable at least at the pockets to allow penetration of the exudate into the pockets for absorption by the SAP;

the top and bottom sheets being perforated between the pockets such that exudate on the top sheet can pass through both the top and bottom sheets into the channels for absorption through the bottom sheet into the pockets.

According to a third aspect of the invention there is provided a tray for supporting a food product comprising;

a tray base;

tray walls around the base;

the tray base defining:

a support surface;

a bottom sheet upon the support surface so as to be at least partly in contact therewith;

a top sheet of a liquid impermeable material;

the top and bottom sheets being laminated together to define a plurality of pockets therebetween;

the pockets each containing a quantity of a super absorbent particulate material (SAP);

the pockets being spaced each from the next to define channels between the pockets which channels are located underneath the bottom sheet so as to be located between the bottom sheet and the support surface;

the bottom sheet being liquid permeable at least at the pockets to allow penetration of the exudate into the pockets for absorption by the SAP;

the top and bottom sheets being perforated between the pockets such that exudate on the top sheet can pass through both the top and bottom sheets into the channels for absorption through the bottom sheet into the pockets.

According to a fourth aspect of the invention there is provided a method for packaging a food product having a liquid exudate from the product, the method comprising:

providing an absorbent layer for absorbing the exudate from the product and locating the product on the layer;

wherein the layer comprises:

a flat top sheet of a liquid impermeable material;

a bottom sheet;

the bottom sheet being shaped to define a plurality of pockets recessed from an upper surface of the bottom sheet to define an upper open face of the pockets;

the top sheet being laminated to the lower sheet between the pockets so as to close the upper open face of the pockets;

the pockets each containing a quantity of a super absorbent particulate material (SAP);

at least the lower sheet being perforated at the pockets to allow penetration of the exudate into the pockets for absorption by the SAP;

locating the pad on a support surface with the pockets engaging the support surface and supporting the lower sheet at locations intervening the pockets away from the support surface so as to define channels between the pockets;

arranging the product on the pad with the pockets spaced and arranged such that the pockets define a plurality of channels underneath the product in a longitudinal direction of the pad and a plurality of channels underneath the product in a transverse direction of the pad;

such that exudate passing to the support surface can flow along the channels for accessing a plurality of the pockets for absorption thereby.

According to a fifth aspect of the invention there is provided a method for packaging a food product having a liquid exudate from the product, the method comprising:

providing an absorbent layer for absorbing the exudate from the product and locating the product on the layer;

wherein the layer comprises:

a top sheet of a liquid impermeable material;

a bottom sheet;

the bottom sheet being laminated to the top sheet to define a plurality of pockets;

the pockets each containing a quantity of a super absorbent particulate material (SAP);

at least the lower sheet being perforated at the pockets to allow penetration of the exudate into the pockets for absorption by the SAP;

locating the pad on a support surface with the pockets engaging the support surface so as to define channels between the pockets with the channels located underneath the bottom sheet between the bottom sheet and the support surface;

arranging the product on the pad with the pockets spaced and arranged such that the pockets define a plurality of channels underneath the product in a longitudinal direction of the pad and a plurality of channels underneath the product in a transverse direction of the pad;

wherein the pockets are arranged in rows and columns and wherein the pockets of each row overlap with the pockets of the next adjacent row.

According to a sixth aspect of the invention there is provided a method for packaging a food product having a liquid exudate from the product, the method comprising:

providing an absorbent layer for absorbing the exudate from the product and locating the product on the layer;

wherein the layer consists solely of:

a top sheet of a liquid impermeable material;

a bottom sheet;

the bottom sheet being laminated to the top sheet to define a plurality of pockets;

the pockets each containing a quantity of a super absorbent particulate material (SAP);

the lower sheet being liquid permeable at least at the pockets to allow penetration of the exudate into the pockets for absorption by the SAP;

the top sheet being imperforate at the pockets to prevent penetration of the exudate through the top sheet into the pockets and to prevent escape of the SAP;

and locating the pad on a support surface with the pockets engaging the support surface so as to define channels between the pockets with the channels located underneath the bottom sheet between the bottom sheet and the support surface.

One concept of our product is to use all film for the top and bottom sheets and SAP. The cup side of the product rests on the bottom of the package and the smooth side faces up. The meat is placed on the smooth side. Small perforations are placed in the top of the film and also into each cup. Alternatively, we may want to consider a porous film or a nonwoven. Most of the exudate will flow off the top of the pad and then underneath through the channels between the cups. The SAP will draw the liquid into each cup where it will be stored. As a cup fills the liquid will go to the next cup so as to get even distribution of the absorbed liquid.

This technology could be incorporated into a tray design with stiffer materials than would be used for the pad.

The composite could be provided in pad form already cut to size or may be provided in a roll or spooled form for cutting to length and/or size.

The SAP can be placed loosely into each pocket, or may be fixated to each pocket with the use of adhesive which may be in hot melt or powder form.

The structure of the bottom sheet may not necessarily be firm or stiff enough that pockets act to support the parts of the pad between the pockets away from the surface and thus define the channels are maintained in the absence of exudate. The pockets may be collapsed or flaccid at the start, but as the SAP is activated the pockets swell and the channels are formed.

In an alternative arrangement, the pad is inverted or turned over so that the pockets are against the meat. This will prevent pooling of exudate on the top. The smooth film (now on the bottom) can be perforated. Fluid can go through the smooth film between the pockets and then back up into each individual pocket.

Yet another option is to have pockets in both the top and bottom sheets so as to extend up and down and arranged in aligned positions so that the pockets match up.

The design can also be integrated into a tray. In other words, the sides and bottom of the tray would all be one piece. A gap can be provided running around the edge of the tray on the inside with the platform that the meat rests on elevated by the height of the pockets.

Some key differences from the Sealed Air patent above is as follows:

The cells are defined as being between 40 mm and 100 mm in width. The cells of the arrangements described hereinafter are much smaller in size and larger in number.

The above patent does not refer to any channels between the cells, whereas a key part of the present arrangement is to have channels allowing flow to each individual cell.

While the present invention is primarily concerned with pads for absorbing exudate from food products, there are a variety of absorbent products used for absorbing oil, ink and other industrial wastes. This product could have an application in these areas, as well as personal care applications.

### BRIEF DESCRIPTION OF THE DRAWINGS

Embodiments of the invention will now be described in conjunction with the accompanying drawings, in which:

FIG. 1 is a top plan view of a first embodiment of an absorbent pad for food products according to the present invention.

FIG. 2 is a top plan view of a second embodiment of an absorbent pad for food products according to the present invention.

FIG. 3 is a top plan view on an enlarged scale of the first embodiment of FIG. 1 of an absorbent pad for food products according to the present invention.

FIGS. 4 to 9 are a series of cross sectional views through different embodiments of the pad according to the present invention.

FIG. 10 is a cross sectional view through an embodiment in which the concept of the present invention is incorporated into the construction of a tray.

FIG. 11 is a schematic illustration of a method for forming the pad of FIGS. 1 and 2.

In the drawings like characters of reference indicate corresponding parts in the different figures.

### DETAILED DESCRIPTION

The present invention can be incorporated into a pad or layer which is applied into a tray so that the pad or layer is laid across a supporting surface of the tray to act as an absorbent layer for collecting exudate from a food product placed onto the layer.

In the alternative the same concept can be utilized directly in a tray so that the construction of the tray itself provides the same absorbent layer onto a non absorbent bottom surface of the tray as an integral structure.

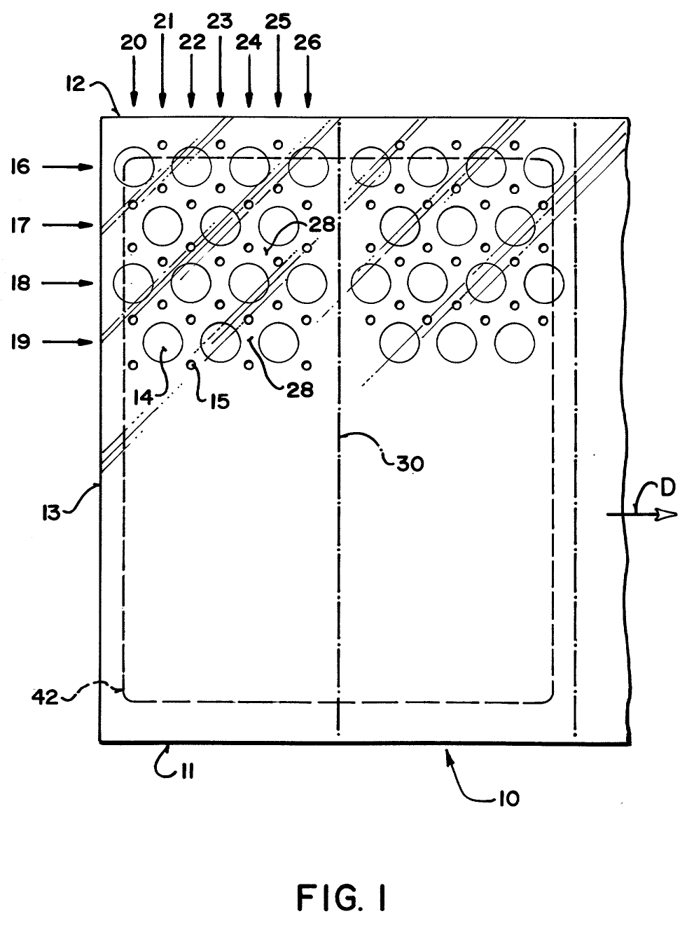

In FIG. 1 is shown one example of the layer generally indicated at 10 which is formed in a continuous roll or strip with side edges 11 and 12 of the strip and a leading edge 13 with the remainder of the roll or strip being continuous in a direction D and rolled onto a roll or spool of the strip. The strip is formed by the method as described hereinafter to provide pockets 14 of absorbent material and perforated holes 15 of absorbent material. The pockets are arranged in an array in rows and columns so that there are rows 16, 17, 18 and 19 and the columns 20 through 27 are shown. It will be appreciated that the rows and columns are merely examples and the number of rows and columns can vary widely as can the sizes of the pockets. It will be noted in FIG. 1 that the pockets of the columns 21, 23 and 25 are offset so as to be placed intermediate the pockets of the columns 20, 22, 24 and 26. This arranges the pockets diagonally.

In between the pockets are located channels 28 which allow fluid to flow between the pockets so that fluid entering at one edge of the sheet can run between the channels and around the pockets to access the pockets at different positions across the sheet. Thus fluid entering at the edge 13 can pass between two of the pockets and will then encounter the next adjacent pocket of the next column. Fluid entering from the edge 12 can pass between the pockets and, in view of the overlapping of the pockets of the next row 17 will immediately encounter the next pocket.

In between the pockets are provided the holes 15 which access the channels as described hereinafter.

In FIG. 1 it will be noted that a transverse line 30 is provided which extends across the sheet which can form a cut line without intersecting any of the pockets. Thus the overlapping arrangement of the pockets is halted at the imaginary transverse cut line 30 to provide a band or strip across the sheet at which cutting can occur. The spacing of the transverse lines or bands 30 can thus be provided at locations which allow the continuous strip to be cut into sheets of predetermined length. Thus if the bands or lines 30 are located at two inch spacing, sheets of a multiple of two inches can be cut as required for different size uses for example sheets of four inches, six inches, eight inches etc. can be provided as required.

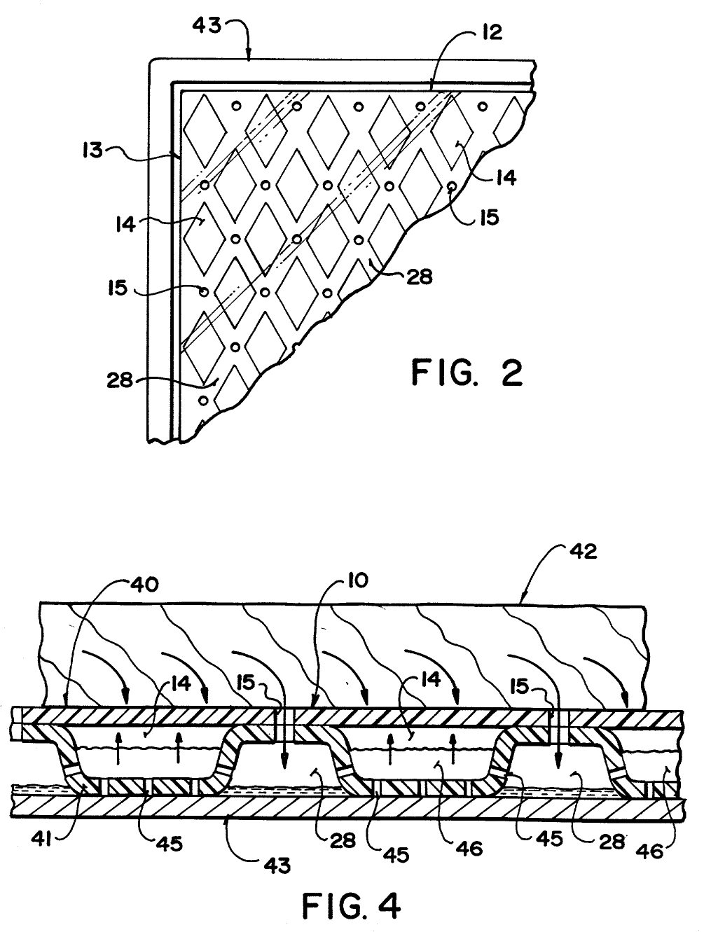

In FIG. 2 is shown a similar arrangement in which the pockets are not circular as shown in FIG. 1 but are instead diamond shaped so as to provide more discreet diagonal channels across the sheet between the pockets.

It will be noted in FIGS. 1 and 2 that the number of pockets is relatively large so that each sheet has a plurality of channels both transversely and longitudinally defined by either the areas between the circular pockets of FIG. 1 or the discreet generally straight channels heading in the diagonal directions as shown in FIG. 2. In both cases where a food product is located over the sheet it will cover substantially all of the sheet and thus lie over the majority of the pockets so that underneath the food product is provided a multitude of channels in the longitudinal and transverse direction of the sheet to allow the fluid to pass along those channels and to access substantially all of the pockets by flowing along the channels as required. In both the longitudinal and transverse directions, therefore, there are more than four pockets in each direction thus providing more than 16 pockets in total and in most cases there will be significantly more pockets of a relatively small nature to provide a large number of channels by providing a relatively large area defining the total area of pockets for containing a large quantity of the SAP.

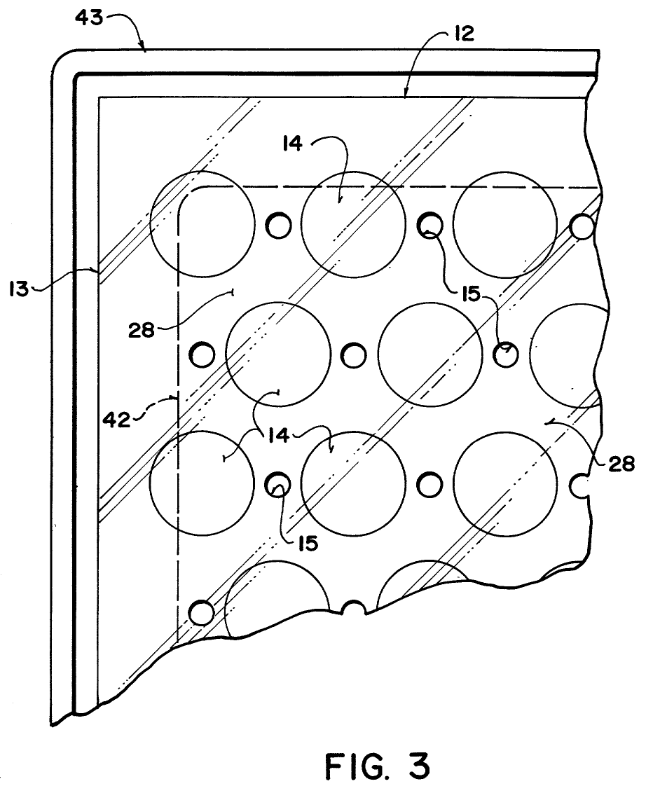

In FIG. 3 is shown a simplified version of the arrangement of FIG. 1 in which there are pockets 14 again arranged in rows and columns and between each pocket and the next is provided a hole 15 with that hole being relatively large and substantially filling the area between the pockets. However the holes may be reduced in size relative to those shown in FIG. 3 and increased in number provided the holes 15 are located so that they do not overlap with the pockets but are located in the positions between the pockets so as to communicate between the top of the pad or layer and the bottom of the pad or layer without intersecting the individual pockets.

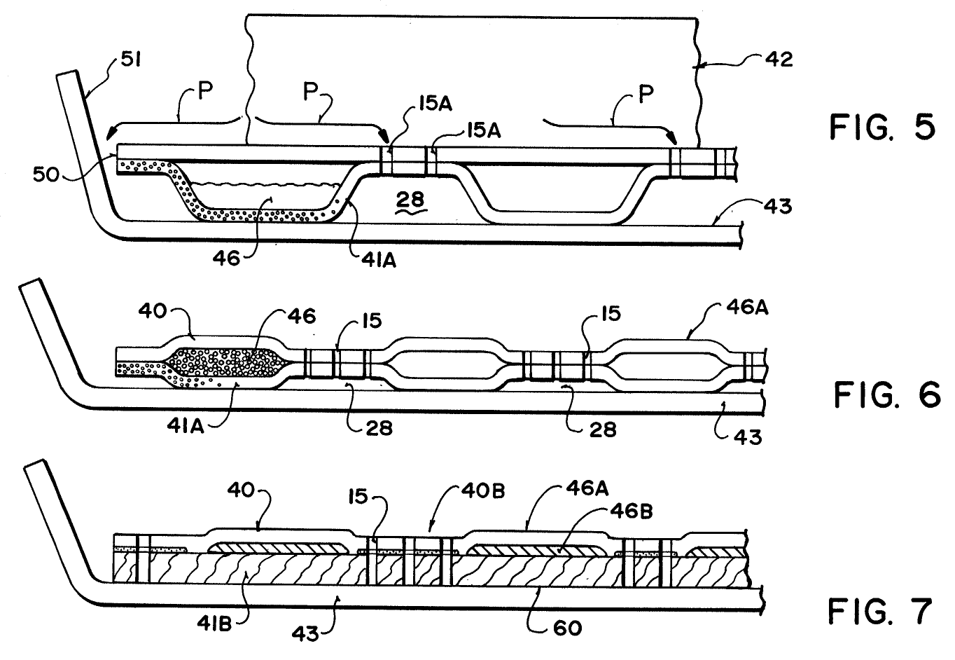

In FIG. 4 is shown a primary embodiment of the invention in which the pad or layer 10 is formed from a top sheet 40 and a bottom sheet 41 for use with a food product 42 on a tray 43. The food product 42 can be any material which generates an exudate such as steak, poultry, fish or other material and the food product lays on top of the upper surface of the top sheet 40. The lower surface of the bottom sheet 41 sits on the non absorbent upper surface of the tray 43 with the tray generally being formed of a polystyrene foam or the like which is inexpensive and disposable but is not intended to absorb any of the exudate.

In the embodiment shown in FIG. 4 the bottom sheet 41 is distorted to form a series of cups or pockets which space the bottom sheet away from the top sheet at the pockets leaving the bottom sheet laminated to the top sheet in between the pockets by heat sealing or the application of suitable adhesive. In the embodiment shown in FIG. 4 the pockets are distorted away from the top sheet so as to hold the top sheet and the laminated portions of the bottom sheet away from the support surface of the tray 43 so that the channels 28 are formed underneath the bottom sheet between the pockets and on top of the tray 43 and are maintained open as air spaces to be partially or fully filled with the exudate fluid as the fluid enters the channels. Thus the exudate is free to enter the channels without the necessity to push or lift the sheets away from the support surface thus displacing the air space defined in the channels.

In the embodiment of FIG. 4 both the top sheet and the bottom sheet are formed from impermeable plastics material such as polyethylene, polyester, polypropylene or the like which are inexpensive and heat sealable allowing the lamination between the pockets to occur simply by heat sealing action without the necessity for adhesive. However materials that do not heat seal are also suitable in this case a suitable adhesive is applied in the areas between the pockets to provide the lamination.

Both sheets are thus formed of a material which is basically impermeable to the exudate fluid but the bottom sheet is perforated with holes 45 at spaced positions across the sheet so that the holes intersect with the pockets and allow the penetration of the exudate fluid from the channels into the pockets through the holes. The size and number of the holes can be varied but is intended that the pockets will each have a plurality of holes for example of a size of the order of 0.030 inch which are sufficient in size to allow the penetration of the fluid while preventing the escape of SAP from the interior of the pocket. Thus the intention of the holes is to provide a high or maximum penetration of the fluid into the pockets while preventing the escape of SAP in particulate form and subsequently in gelled form after absorption of the liquid. The size and number of the holes is thus selected so that the particles cannot escape while the liquid can penetrate and so that pressure within the pockets does not cause the holes to split or to tear between holes thus forming one large hole which could allow the pressure of the gel to cause the gel to escape widely into the channels so that the gel and SAP remain contained within the pockets at all times during the operation of the device.

The top sheet is not perforated into the pockets so that there is no possibility for the SAP to escape through the top sheet from the pocket since the top sheet is impermeable at this location. However between the pockets the holes 15 are provided which penetrate both the top sheet and the bottom sheet thus providing access from the food product and the exudate therefrom through the holes 15 to the channels. As the channels are maintained free from the SAP both in particulate and in gelled form, there is no possibility for the SAP to access the food product so there is no possibility for the SAP to provide a desiccating effect on the food product during normal operation.

As shown in the embodiment of FIG. 4 the bottom sheet is sufficiently stiff so that the pockets maintain the channels open even though the amount of SAP 46 in the pocket in the initial particulate state is insufficient to fill the pocket and thus maintain the pocket in its distorted condition. Thus there is an air space in the pocket above the SAP and underneath the top sheet with the intention that the air space will subsequently be filled as the SAP expands during the absorption process. The air space may be selected relative to the amount of SAP and the size of the pocket so that the SAP expands substantially up to filling the pocket without going beyond filling so as to pressurize the pocket thus avoiding internal pressure from tending to cause the SAP in its gelled form from being extruded or expelled through the holes 45.

In the embodiment of FIG. 4 the top sheet is flat so as to provide a smooth flat top surface of an attractive appearance onto which the food product can be located thus avoiding the appearance of bumps or projections which could detract from the appearance or could interfere with the bottom surface of the food product itself and detracts from the food product as it is removed from the packaging for use. The top sheet can be opaque so that the exudate as it passes through the top sheet and is absorbed under the top sheet is removed from view so that its color is no longer visible.

Turning now to FIG. 5 a further embodiment is shown which is similar in construction to that of FIG. 4 except that the bottom sheet 41A is formed of a permeable material such as a spun bonded fibrous material so that there is no longer any necessity to provide discreet holes punch in the bottom sheet 41A since the bottom sheet is permeable to the liquid. Suitable spun bonded materials are well known and such materials have a fibrous structure which is itself not absorbent but which provides pores between the fibers which allow the penetration of the exudate fluid but which prevent the escape of the SAP in particulate or gel form. It is not intended in FIG. 5 that the fibrous layer of the sheet 41A provides any absorption but simply acts as an envelope to maintain the SAP in place and to provide the structure of the pockets. Suitable material can be selected which is heat bondable to the top layer 40 or which can be laminated to the top layer by adhesive. This material avoids the necessity for perforation during the method as described hereinafter, but may increase costs and the material itself is of higher cost than the impermeable plastics film.

In FIG. 5 the holes 15 are replaced by holes 15A which are smaller in size and increased in number but which allow again the exudate liquid to pass from the area under the food product 42 into the channels 28.

Also in FIG. 5 is shown an edge 50 of the pad so that the exudate liquid from the food product can pass between the edge 50 of the pad and the upturned sidewall 51 of the tray 43. Thus the passage of the exudate is indicated at arrows P where the liquid can flow across the bottom surface of the food product over the flat top surface of the top sheet 40 to the edge 50 or to the holes 15A.

In FIG. 6 is shown a yet further alternative arrangement in which the top sheet 40 is again of an impermeable material and the bottom sheet 41A is of the fibrous permeable material described above. In this arrangement, however, the bottom sheet 41A is not distorted into pockets but instead the SAP 46 is simply located between the sheets so that it distorts the top sheet upwardly and the bottom sheet downwardly in the areas where the SAP is provided. Thus the top sheet has raised projecting areas 46A at the areas of the SAP and channeled between the raised projections 46A. The bottom sheet 41A is similarly distorted thus providing the channels 28. Holes 15 are again provided through the two sheets in the areas between the raised projections 46A allowing the liquid to pass into the channels 28.

In the embodiment of FIG. 6 there is no permanent distortion of either of the top and bottom sheets so that the only bulging or pushing of those sheets is effected by the presence of the SAP therebetween. The material of the sheets is therefore selected so that the top and/or bottom sheet can slightly expand to accommodate the expansion of the SAP during the absorption process. Thus the pockets at the raised sections 46A are expanded as the SAP expands thus tending to increase the size the of the channel 28 as the liquid is further absorbed.

In FIG. 7 it is shown a yet further embodiment in which the bottom sheet 41 is replaced by a sheet 41B of an air laid fibrous material which has some ability to effect absorption of liquid. In this arrangement the SAP 46B is located in areas on top of the air laid sheet 41B and the top sheet 40 is laminated as previously described to the bottom sheet in areas 40B between the raised sections 46A at the SAP 46B. Holes 15 are provided as previously described through the top sheet and through the air laid material to the bottom surface of the air laid material. In this embodiment the air laid material can be relatively thick so that it tends to remain flat at the bottom surface without the formation of pockets or channels but the inherent absorption of the air laid material allows the liquid to pass along the interface 60 between the tray 43 and the bottom surface of the air laid material 41B.

In FIG. 8 is shown a further embodiment similar to that shown in FIG. 4 except that the holes 15 are omitted and instead all of the exudate passes around the edge 50 into the channels 28. As previously described the pockets are arranged in the bottom sheet so as to provide raised channels 28 allowing the liquid to readily flow between the channels intersecting the individual pockets. Thus if pockets at the edge 50 become filled with absorbed exudate, those pockets increase in size thus increasing the size of the channels therebetween and allowing the liquid to flow to the next adjacent pockets of the next row or column in view of the large number of channels and in view of the diagonal flow of the channels caused by the offset of the pockets.

In FIG. 9 is shown a yet further example similar to that of FIG. 4 except that the top sheet 40 is also perforated at holes 65 into the interior of the pockets. In this embodiment again the channels are arranged as described above so as to provide an effective flow of the materials underneath the pad but in addition the small holes 65 are selected so that some liquid can pass through those holes into the pockets directly from the top surface but the holes are sized and arranged to avoid the possibility of desiccation of the food product by directly contacting the SAP within the pockets. Thus the amount of SAP can be selected so that it never causes the SAP to push up against the undersurface of the top sheet either in the particulate or in the expanded gel form so that there is no contact of the SAP with the food product on the top sheet raised away from the SAP by the airspace between the SAP and the bottom surface of the top sheet.

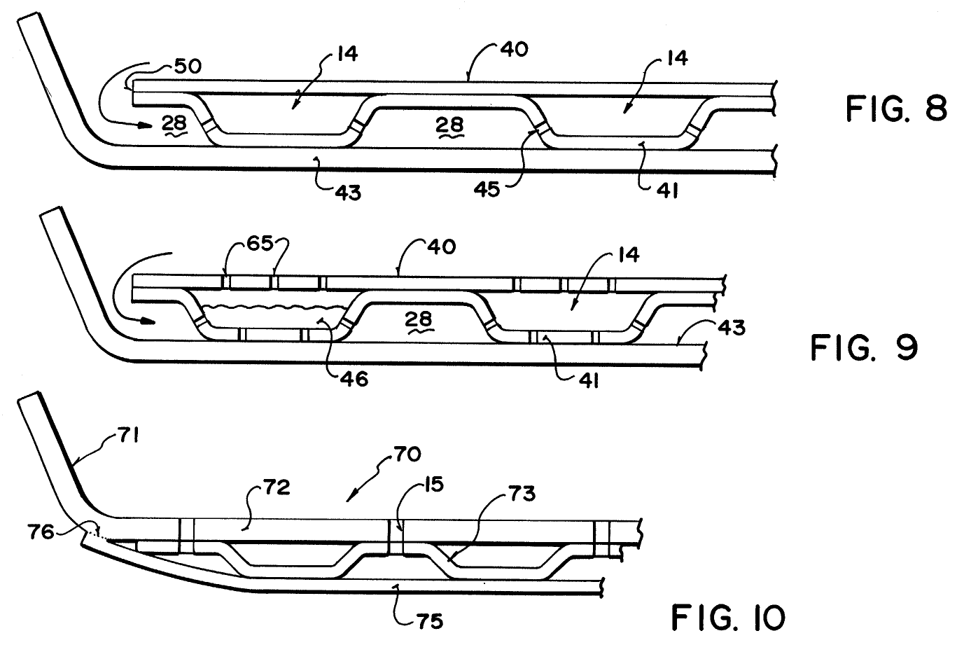

In FIG. 10 is shown a further modified arrangement in which the concepts described above incorporated directly into a tray 70 where the tray is formed integrally at three components including an upper component 71 defining the base 72 on which the food product sits and side walls containing the food product. The bottom sheet 73 is laminated to the base 72 with the holes 15 passing through the base 72 and the bottom sheet 73. A closure sheet 75 is applied over the bottom sheet and is fastened at surrounding seal 76 so as to form a bottom of the tray which sits on the support or on other trays. Thus instead of providing a separate pad within the tray, the construction of the pad is integrated into the tray structure itself utilizing all of the concepts described above.

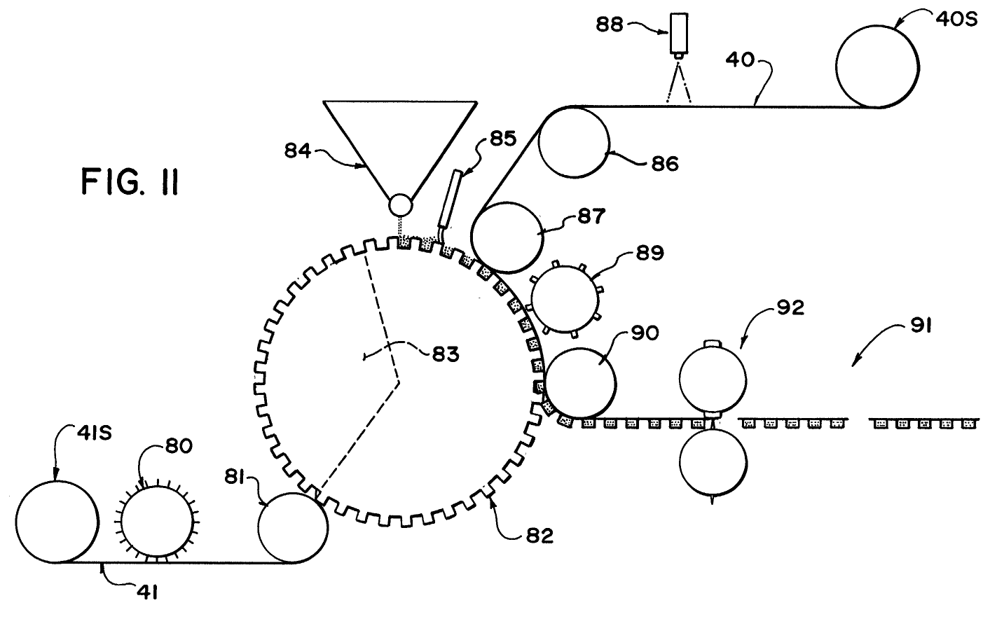

Turning now to FIG. 11 there is shown a method for manufacturing the pad or layer previously described in which a supply roll 41S of the bottom sheet 41 is provided together with a supply roll 40S of the top sheet 40. In the event that the bottom sheet 41 is of the impermeable material, it is initially passed in contact with a perforation wheel 80 which acts to provide the perforations in a pattern matching the pockets as previously described or in a pattern which covers the whole of the sheet. The sheet 41 is carried by a roller 81 onto a main transport roller 82 which has a surface defining a plurality of pockets for vacuum forming the sheet 40 into the pocket shapes in a vacuum forming section 83. At the top of the transport roller 82 is provided a dosing unit 84 for supplying the SAP. In an arrangement in which there are pockets, the SAP can simply be deposited onto the whole area of the sheet 41 and wiped over the pockets by a wiper 85. In an alternative arrangement the dosing unit can be arranged to deposit the material into the area of the pockets in required amounts leaving other areas of the sheet free from the SAP material. This allows the pockets to be only partly filled leaving an airspace and allows an arrangement in which there are no pockets but instead the material is simply deposited in the required areas to form the pockets by the lamination process. The second sheet 40 passes over guide rollers 86 and 87 onto the top surface of the bottom sheet 41 for lamination thereto. The lamination can be effected by heat sealing at the roller 87 or by application of adhesive at an applicator 88 immediately upstream of the roller 87.

After lamination the holes 15 are formed by a perforation wheel 89 and a laminated product including the SAP, the bottom sheet and the top sheet is extracted from the transport roller 82 by a guide roller 90 to a packaging system generally indicated at 91 which includes a cut off system 92 and a stacking system or includes a spooling or winding system (not shown) for winding the continuous strip from the roller 90 into a roll or spool.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

I claim:

1. A method for packaging a food product having a liquid exudate from the product, the method comprising:
providing an absorbent layer for absorbing the exudate from the product and locating the product on the layer;
locating the layer on a liquid impermeable, non absorbent support surface;
wherein the layer comprises:
a top sheet of a liquid impermeable material;
a bottom sheet;
the top and bottom sheets being laminated together to form a plurality of pockets therebetween;
the pockets each containing a quantity of a super absorbent particulate material (SAP);
the pockets being spaced each from the next to define channels between the pockets which channels are located underneath the bottom sheet so as to be located between the bottom sheet and the support surface;
the bottom sheet being liquid permeable at least at the pockets to allow penetration of the exudate into the pockets for absorption by the SAP;
the top and bottom sheets being perforated between the pockets such that exudate on the top sheet can pass through both the top and bottom sheets into the channels for absorption through the bottom sheet into the pockets.

2. The method according to claim 1 wherein the pockets are spaced and arranged such that the pockets define a plurality of channels underneath the product in a longitudinal direction of the pad and a plurality of channels underneath the product in a transverse direction of the pad;

3. The method according to claim 1 wherein the top sheet is substantially flat so as to define a top flat surface on which the food product sits.

4. The method according to claim 1 wherein the bottom sheet is arranged such that, at least when exudate is absorbed by the SAP, the pockets are shaped to project downwardly from the top sheet to support the top sheet at the channels away from the support surface to allow free flow of the exudate in the channels between the bottom sheet and the support surface.

5. The method according to claim 1 wherein the pad consists only of the top and bottom sheets with the SAP in the pockets.

6. The method according to claim 5 wherein the top and bottom sheets are each formed of a single layer only of a plastics material.

7. The method according to claim 1 wherein the SAP in non-hydrated form only partly fills pocket leaving an upper air space underneath the top sheet.

8. The method according to claim 7 wherein the amount of the SAP in each pocket is arranged such that the pocket is not filled when the SAP therein is fully hydrated.

9. The method according to claim 8 wherein the pockets are arranged such that the pockets project downwardly from the top sheet to support the top sheet at the channels away from the support surface to allow free flow of the exudate in the channels between the bottom sheet and the support surface.

10. The method according to claim 9 wherein the pockets are arranged by the shape and arrangement of the bottom sheet which is stiff enough to support the top sheet raised from the support surface.

11. The method according to claim 1 wherein the pockets contain only SAM with no fibrous absorbent material therein.

12. The method according to claim 1 wherein the pockets are arranged in rows and columns and wherein the pockets of each row are longitudinally offset from the pockets of the next adjacent row.

13. The method according to claim 1 wherein the pockets are arranged in rows and columns and wherein the channels between the pockets extend diagonally of the rows and columns.

14. The method according to claim 1 wherein the pockets are arranged in rows and columns each containing more than four.

15. The method according to claim 1 wherein there are more than 16 pockets on the pad.

16. The method according to claim 12 wherein there is provided a band across the layer which is free from pockets allowing the layer to be cut across the band without cutting through a pocket.

17. The method according to claim 1 wherein the support surface comprises the bottom of a tray and the layer comprises a separate element located in the tray.

18. The method according to claim 1 wherein the top sheet, the bottom sheet and the support surface all form integral components of a tray.

19. The method according to claim 1 wherein the bottom sheet is formed from impermeable plastics material which is perforated at the pockets.

20. The method according to claim 1 wherein the bottom sheet is formed from a non woven fibrous material which is permeable to liquid and which is substantially impermeable to the SAM.

21. An absorbent layer for absorbing the exudate from a food product comprising;
a top sheet of a liquid impermeable material;
a bottom sheet arranged to be placed upon a support surface so as to be at least partly in contact therewith;
the top and bottom sheets being laminated together to define a plurality of pockets therebetween;
the pockets each containing a quantity of a super absorbent material (SAM);
the pockets being spaced each from the next to define channels between the pockets which channels are located underneath the bottom sheet so as to be located between the bottom sheet and the support surface;
the bottom sheet being liquid permeable at least at the pockets to allow penetration of the exudate into the pockets for absorption by the SAM;
the top and bottom sheets being perforated between the pockets such that exudate on the top sheet can pass through both the top and bottom sheets into the channels for absorption through the bottom sheet into the pockets.

22. The absorbent layer according to claim 21 wherein the pockets are spaced and arranged such that the pockets define a plurality of channels underneath the product in a longitudinal direction of the pad and a plurality of channels underneath the product in a transverse direction of the pad;

23. The absorbent layer according to claim 21 wherein the top sheet is substantially flat so as to define a top flat surface on which the food product sits.

24. The absorbent layer according to claim 21 wherein the bottom sheet is arranged such that, at least when exudate is absorbed by the SAM, the pockets are shaped to project downwardly from the top sheet to support the top sheet at the channels away from the support surface to allow free flow of the exudate in the channels between the bottom sheet and the support surface.

25. The absorbent layer according to claim 21 wherein the layer consists only of the top and bottom sheets with the SAM in the pockets.

26. The absorbent layer according to claim 25 wherein the top and bottom sheets are each formed of a single layer only of a plastics material.

27. The absorbent layer according to claim 21 wherein the SAM in non-hydrated form only partly fills pocket leaving an upper air space underneath the top sheet.

28. The absorbent layer according to claim 27 wherein the amount of the SAM in each pocket is arranged such that the pocket not filled when the SAM therein is fully hydrated.

29. The absorbent layer according to claim 21 wherein the pockets are arranged such that the pockets project downwardly from the top sheet to support the top sheet at the channels away from the support surface to allow free flow of the exudate in the channels between the bottom sheet and the support surface.

30. The absorbent layer according to claim 21 wherein the pockets are arranged by the shape and arrangement of the bottom sheet which is stiff enough to support the top sheet raised from the support surface.

31. The absorbent layer according to claim 21 wherein the pockets contain only SAM with no fibrous absorbent material therein.

32. The absorbent layer according to claim 21 wherein the pockets are arranged in rows and columns and wherein the pockets of each row overlap with the pockets of the next adjacent row.

33. The absorbent layer according to claim 21 wherein the pockets are arranged in rows and columns and wherein the channels between the pockets extend diagonally of the rows and columns.

34. The absorbent layer according to claim 21 wherein the pockets are arranged in rows and columns each containing more than four.

35. The absorbent layer according to claim 21 wherein there are more than 16 pockets on the pad.

36. The absorbent layer according to claim 31 wherein there is provided a band across the layer which is free from pockets allowing the layer to be cut across the band without cutting through a pocket.

37. The absorbent layer according to claim 21 wherein the support surface comprises the bottom of a tray and the layer comprises a separate element located in the tray.

38. The absorbent layer according to claim 21 wherein the bottom sheet is formed from impermeable plastics material which is perforated at the pockets.

39. The absorbent layer according to claim 21 wherein the bottom sheet is formed from a non woven fibrous material which is permeable to liquid and which is substantially impermeable to the SAM.

40. A tray for supporting a food product comprising;
a tray base;
tray walls around the base;
the tray base defining:
a support surface;
a bottom sheet upon the support surface so as to be at least partly in contact therewith;
a top sheet of a liquid impermeable material;
the top and bottom sheets being laminated together to define a plurality of pockets therebetween;
the pockets each containing a quantity of a super absorbent material (SAM);
the pockets being spaced each from the next to define channels between the pockets which channels are located underneath the bottom sheet so as to be located between the bottom sheet and the support surface;
the bottom sheet being liquid permeable at least at the pockets to allow penetration of the exudate into the pockets for absorption by the SAM;
the top and bottom sheets being perforated between the pockets such that exudate on the top sheet can pass through both the top and bottom sheets into the channels for absorption through the bottom sheet into the pockets.

41. The tray according to claim 40 wherein the pockets are spaced and arranged such that the pockets define a plurality of channels underneath the product in a longitudinal direction of the pad and a plurality of channels underneath the product in a transverse direction of the pad.

42. The tray according to claim 40 wherein the top sheet is substantially flat so as to define a top flat surface on which the food product sits.

43. The tray according to claim 40 wherein the bottom sheet is arranged such that, at least when exudate is absorbed by the SAM, the pockets are shaped to project downwardly from the top sheet to support the top sheet at the channels away from the support surface to allow free flow of the exudate in the channels between the bottom sheet and the support surface.

44. The tray according to claim 40 wherein the layer consists only of the top and bottom sheets with the SAM in the pockets.

45. The tray according to claim 40 wherein the top and bottom sheets are each formed of a single layer only of a plastics material.

46. The tray according to claim 40 wherein the SAM in non-hydrated form only partly fills pocket leaving an upper air space underneath the top sheet.

47. The tray according to claim 46 wherein the amount of the SAM in each pocket is arranged such that the pocket not filled when the SAM therein is fully hydrated.

48. The tray according to claim 40 wherein the pockets are arranged such that the pockets project downwardly from the top sheet to support the top sheet at the channels away from the support surface to allow free flow of the exudate in the channels between the bottom sheet and the support surface.

49. The tray according to claim 40 wherein the pockets are arranged by the shape and arrangement of the bottom sheet which is stiff enough to support the top sheet raised from the support surface.

50. The tray according to claim 40 wherein the pockets contain only SAM with no fibrous absorbent material therein.

51. The tray according to claim 40 wherein the pockets are arranged in rows and columns and wherein the pockets of each row overlap with the pockets of the next adjacent row.

52. The tray according to claim 40 wherein the pockets are arranged in rows and columns and wherein the channels between the pockets extend diagonally of the rows and columns.

53. The tray according to claim 40 wherein the pockets are arranged in rows and columns each containing more than four.

54. The tray according to claim 40 wherein there are more than 16 pockets on the pad.

55. The tray according to claim 40 wherein the bottom sheet is formed from impermeable plastics material which is perforated at the pockets.

56. The tray according to claim 40 wherein the bottom sheet is formed from a non woven fibrous material which is permeable to liquid and which is substantially impermeable to the SAM.

57. A method for packaging a food product having a liquid exudate from the product, the method comprising:
providing an absorbent layer for absorbing the exudate from the product and locating the product on the layer;
wherein the layer comprises:
a flat top sheet of a liquid impermeable material;
a bottom sheet;
the bottom sheet being shaped to define a plurality of pockets recessed from an upper surface of the bottom sheet to define an upper open face of the pockets;
the top sheet being laminated to the lower sheet between the pockets so as to close the upper open face of the pockets;
the pockets each containing a quantity of a super absorbent material (SAM);
at least the lower sheet being perforated at the pockets to allow penetration of the exudate into the pockets for absorption by the SAM;
locating the pad on a support surface with the pockets engaging the support surface and supporting the lower sheet at locations intervening the pockets away from the support surface so as to define channels between the pockets;
arranging the product on the pad with the pockets spaced and arranged such that the pockets define a plurality of channels underneath the product in a longitudinal direction of the pad and a plurality of channels underneath the product in a transverse direction of the pad;
such that exudate passing to the support surface can flow along the channels for accessing a plurality of the pockets for absorption thereby.

58. A method for packaging a food product having a liquid exudate from the product, the method comprising:
providing an absorbent layer for absorbing the exudate from the product and locating the product on the layer;
wherein the layer comprises:
a top sheet of a liquid impermeable material;
a bottom sheet;
the bottom sheet being laminated to the top sheet to define a plurality of pockets;
the pockets each containing a quantity of a super absorbent material (SAM);
at least the lower sheet being perforated at the pockets to allow penetration of the exudate into the pockets for absorption by the SAM;
locating the pad on a support surface with the pockets engaging the support surface so as to define channels between the pockets with the channels located underneath the bottom sheet between the bottom sheet and the support surface;
arranging the product on the pad with the pockets spaced and arranged such that the pockets define a plurality of channels underneath the product in a longitudinal direction of the pad and a plurality of channels underneath the product in a transverse direction of the pad;
wherein the pockets are arranged in rows and columns and wherein the pockets of each row overlap with the pockets of the next adjacent row.

59. A method for packaging a food product having a liquid exudate from the product, the method comprising:
providing an absorbent layer for absorbing the exudate from the product and locating the product on the layer;
wherein the layer consists solely of:
a top sheet of a liquid impermeable material;
a bottom sheet;
the bottom sheet being laminated to the top sheet to define a plurality of pockets;
the pockets each containing a quantity of a super absorbent material (SAM);
the lower sheet being liquid permeable at least at the pockets to allow penetration of the exudate into the pockets for absorption by the SAM;
the top sheet being imperforate at the pockets to prevent penetration of the exudate through the top sheet into the pockets and to prevent escape of the SAM;
and locating the pad on a support surface with the pockets engaging the support surface so as to define channels between the pockets with the channels located underneath the bottom sheet between the bottom sheet and the support surface.
